(19) United States
(12) Patent Application Publication
(10) Pub. No.: US 2002/0174685 A1
(43) Pub. Date: Nov. 28, 2002

(54) Dielectric lens and dielectric lens manufacturing method

(76) Inventor: Hiroshi Nonogaki, Gamo-gun (JP)

Correspondence Address: OSTROLENK FABER GERB & SOFFEN, 1180 AVENUE OF THE AMERICAS, NEW YORK, NY, 100368403

(21) Appl. No.: 10/107,636

(22) Filed: Mar. 25, 2002

(30) Foreign Application Priority Data
Apr. 23, 2001 (JP) 2001-124346

(51) Int. Cl. G02B 3/00; C03B 11/08; C03B 27/00

(52) U.S. Cl. 65/37; 343/909; 65/40; 264/1.32

(57) ABSTRACT

A dielectric lens is formed by laminating a plurality of dielectric sheets having different diameters along a focal axis of the lens. The first dielectric sheet is formed by injecting a dielectric material in a molten state at a predetermined pressure and cooling and solidifying the dielectric material. Each successive dielectric sheet is formed by injecting the dielectric material in a molten state on the preceding dielectric sheet and cooling and solidifying the dielectric material, so that each successive dielectric sheet and each immediately preceding dielectric sheet are fusion-bonded to each other.

### BACKGROUND OF THE INVENTION

1. Field of the Invention

The present invention relates to a dielectric lens for high-frequency waves such as microwaves and millimeter waves, and to a manufacturing method for the dielectric lens.

2. Description of the Related Art

Dielectric lenses used in antennas, radars, etc., for transmitting and receiving electric waves have a function of increasing directivity of the electric waves on transmission and focusing weak electric waves on reception. In general, dielectric lenses are formed of a synthetic resin such as polypropylene, etc., in a hemispherical shape by integral injection molding.

When dielectric lenses are formed by integral injection molding, since the overall body thereof is relatively thick and the shape thereof is non-uniform such that the peripheral parts are thinner than the central part, it is difficult to form dielectric lenses in a desired shape due to the difference in contraction rates. In addition, the relative permittivity at the surface may differ from that at the inner part, and the antenna gain may thereby be reduced. Furthermore, since a cool time required in the process of resin molding is proportional to the square of the body thickness, the cool time is increased and productivity is reduced as the body thickness increases.

With respect to a dielectric lens manufacturing method other than injection molding, Japanese Unexamined Patent Application Publication No. 9-130137 discloses a method in which a plurality of dielectric sheets having different diameters are obtained from a material sheet by press molding and are laminated by using an adhesive in the order of their diameters.

As described above, when dielectric lenses are formed by integral injection molding, since the overall body thereof is relatively thick and the shape thereof is non-uniform such that the peripheral parts are thinner than the central part, it is difficult to form dielectric lenses in a desired shape due to the difference in contraction rates. In addition, the relative permittivity at the surface may differ from that at the inner part, and the antenna gain may thereby be reduced.

In addition, jetting easily occurs in the molding process since the space of a cavity is large relative to an injection gate, and the relative permittivity thereby becomes nonuniform at the inner part. In addition, voids are often generated when the body thickness is large, and this also makes the relative permittivity nonuniform. Accordingly, there is a risk that the antenna gain will be reduced for these causes. Furthermore, the flow behavior may become complicated due to the nonuniform shape, and ceramic, which determines the dielectric characteristics of the material, may disperse nonuniformly. This also leads to the reduction of the antenna gain.

In the case in which a dielectric lens is formed by laminating a plurality of dielectric sheets as disclosed in the above-described publication, there is a risk that the dielectric sheets will be separated from each other or a gap will be formed there between when the dielectric lens is used under high temperature conditions.

### SUMMARY OF THE INVENTION

In view of the above-described situation, an object of the present invention is to provide a dielectric lens in which the degradation of antenna characteristics due to separation of dielectric sheets or a gap generated there between can be prevented, and a dielectric lens manufacturing method in which processes can be made simpler and costs can be reduced.

According to one aspect of the present invention, a dielectric lens includes at least a first dielectric sheet and a second dielectric sheet which are laminated along a focal axis, the first dielectric sheet being formed by injecting a dielectric material in a molten state into a die at a predetermined pressure and cooling and solidifying the dielectric material, and the second dielectric sheet being formed by injecting the dielectric material in a molten state into a die in which the first dielectric sheet is disposed and cooling and solidifying the dielectric material.

In the dielectric lens of the present invention, concave and convex portions for increasing a bonding area may be formed at the boundary between the first dielectric sheet and the second dielectric sheet.

In addition, fitting portions for increasing a mechanical bonding strength may be formed at the boundary between the first dielectric sheet and the second dielectric sheet.

According to another aspect of the present invention, a manufacturing method for a dielectric lens, which is formed by laminating at least a first dielectric sheet and a second dielectric sheet along the focal axis, includes a first forming step in which the first dielectric sheet is formed by injecting a dielectric material in a molten state into a die at a predetermined pressure, the die having a shape corresponding to the first dielectric sheet, and cooling and solidifying the dielectric material; and a second forming step in which the second dielectric sheet is formed by injecting the dielectric material in a molten state into a die in which the first dielectric sheet is disposed at a predetermined pressure, the die having a shape such that a cavity corresponding to the second dielectric sheet is formed between the die and the first dielectric sheet, and cooling and solidifying the dielectric material, so that the first dielectric sheet and the second dielectric sheet are fusion-bonded to each other.

According to the present invention, the first dielectric sheet is formed by injection molding, and the second dielectric sheet is formed directly on the first dielectric sheet by injection molding. Accordingly, dielectric lens having a uniform shape in which the body thickness is constant can be obtained, and the difference in contraction rate does not easily occur in the cooling and solidifying process, so that the dielectric lens can be formed in a desired shape. As a result, the antenna gain can be increased.

In addition, jetting does not easily occur in the molding process since the cavity has a flat space relative to an injection gate, and voids are not easily generated since the body thickness of each dielectric sheet is small. Accordingly, the reduction of antenna gain due to these causes can be prevented. Furthermore, since the material is injected into a flat space, the material flows in one direction and ceramic, which determines the dielectric characteristics of the material, disperses uniformly, so that the reduction of antenna gain can be prevented.

In addition, since the first dielectric sheet re-melts in the process of forming the second dielectric sheet by injection molding, the first and second dielectric sheets are easily fusion-bonded to each other. Accordingly, mechanical characteristics similar to those obtained by integral injection molding can be obtained, and the problems such as by separation of the dielectric sheets, etc., can be reliably prevented.

When the concave and convex portions for increasing the bonding area are formed at the boundary between the first dielectric sheet and the second dielectric sheet, the bonding strength can be increased and the problems such as separation of the dielectric sheets, etc., can be reliably prevented.

In addition, when the fitting portions for increasing the mechanical bonding strength are formed at the boundary between the first dielectric sheet and the second dielectric sheet, the bonding strength of the first and second dielectric sheets can be further increased.

In addition, according to the present invention, the first dielectric sheet is formed by injecting the dielectric material in a molten state in the die, and then the second dielectric sheet is formed by injecting the dielectric material in a molten state in the die in which the first dielectric sheet is disposed. Accordingly, the antenna gain can be increased and the first and second dielectric sheets can be reliably fusion-bonded to each other.

Further, in accordance with another aspect of the invention, a dielectric lens includes a plurality of dielectric sheets formed along a focal axis of the lens. A first dielectric sheet is formed by injecting a dielectric material in a molten state at a predetermined pressure and cooling and solidifying of the dielectric material and each successive dielectric sheet is formed by injecting the dielectric material in a molten state on a preceding dielectric sheet and cooling and solidifying the dielectric material so that each successive dielectric sheet and each immediately preceding dielectric sheet are fusion-bonded to each other.

In addition, according to another aspect of the invention, a manufacturing method for a dielectric lens which is formed by a plurality of dielectric sheets disposed along a focal axis of the lens includes forming a first dielectric sheet by injecting a dielectric material in a molten state at a predetermined pressure and cooling and solidifying of the dielectric material; and forming successive dielectric sheets by injecting the dielectric material in a molten state on a preceding dielectric sheet and cooling and solidifying the dielectric material so that each successive dielectric sheet and each immediately preceding dielectric sheet are fusion-bonded to each other.

Advantageously, in accordance with the invention, a dielectric lens includes four dielectric sheets, each having a thickness equal to one quarter the wavelength of the frequency of the electric wave with which the lens is to be used.

Other features and advantages of the present invention will become apparent from the following description of the invention which refers to the accompanying drawings.

### BRIEF DESCRIPTION OF THE DRAWING(S)

FIG. 1 is a sectional view of a dielectric lens according to a first embodiment of the present invention;

FIGS. 2A to 2D are diagrams showing manufacturing processes of the dielectric lens shown in FIG. 1;

FIG. 3 is a perspective view of a dielectric sheet according to a second embodiment of the present invention;

FIG. 4 is a sectional view showing a dielectric lens according to the second embodiment of the present invention;

FIG. 5 is a perspective view of a dielectric sheet according to a modification of the second embodiment;

FIG. 6 is a sectional view of a dielectric sheet according to another modification of the second embodiment;

FIG. 7 is a sectional view showing a dielectric lens according to a third embodiment of the present invention; and

FIG. 8 is a sectional view of a dielectric sheet according to a modification of the third embodiment.

### DETAILED DESCRIPTION THE PREFERRED EMBODIMENTS

Embodiments of the present invention will be described below with reference to the accompanying drawings.

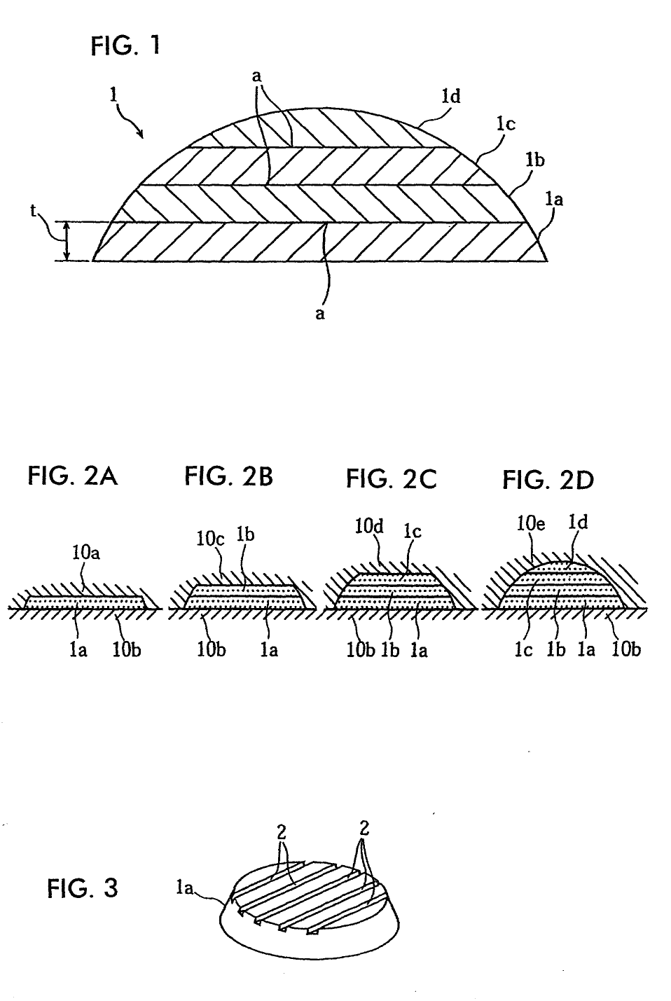

FIG. 1 is a sectional view of a dielectric lens according to a first embodiment of the present invention, and FIGS. 2A to 2D are diagrams showing manufacturing processes of the dielectric lens.

A dielectric lens 1 of the present embodiment is formed by laminating first, second, third, and fourth dielectric sheets 1a, 1b, 1c, and 1d along a focal axis. The dielectric sheets 1a to 1d have different diameters, are hemispherically shaped and are formed of a thermoplastic resin such as polypropylene, etc., or of a composite material including a ceramic and a thermoplastic resin. The thickness t of each of the dielectric sheets 1a to 1d is set to a thickness corresponding to a quarter wavelength (¼λ) of the frequency of the electric wave with which the lens is to be used. The number of dielectric sheets and the thickness thereof may be freely set. For example, when two dielectric sheets are laminated, the thickness of the dielectric sheets is set to one-half of the lens thickness.

Each of the above-described dielectric sheets 1a to 1d is formed by injection molding. More specifically, the first dielectric sheet 1a is formed first by injecting a dielectric material in a molten state at a predetermined pressure and cooling and solidifying the dielectric material. Then, the second dielectric sheet 1b is formed by injecting the dielectric material in a molten state on the upper surface of the dielectric sheet 1a at a predetermined pressure and cooling and solidifying the dielectric material, so that the first dielectric sheet 1a and the second dielectric sheet 1b are bonded together. Similarly, the third dielectric sheet 1c is formed on the second dielectric sheet 1b by injection molding in such a manner that they are bonded together, and the fourth dielectric sheet 1d is formed on the third dielectric sheet 1c by injecting molding in such a manner that they are bonded together.

In the above-described injecting process, melt-solidification layers are formed at boundary surfaces a between the dielectric sheets 1a to 1d, and the dielectric sheets 1a to 1d are fusion-bonded to each other by the melt-solidification layers. In the process of forming the second dielectric sheet 1b on the first dielectric sheet 1a, for example, the bonding surface of the first dielectric sheet 1a re-melts as the dielectric material in a molten state is injected on the first dielectric sheet 1a. Accordingly, the first and second dielectric sheets 1a and 1b are fusion-bonded to each other at the bonding surfaces thereof and the melt-solidification layer is formed. The thus formed melt-solidification layer has the same mechanical characteristics and antenna characteristics as those obtained by integral injection molding. Similarly, the melt-solidification layer is also formed at the boundary surface between the second dielectric sheet 1b and the third dielectric sheet 1c, and at the boundary surface between the third dielectric sheet 1c and the fourth dielectric sheet 1d.

Next, manufacturing processes of the above-described dielectric lens 1 will be described below with reference to FIGS. 2A to 2D.

First, a dielectric material in a molten state is injected into a cavity formed by upper and lower dies 10a and 10b at a predetermined pressure, the upper and lower dies 10a and 10b having shapes such that the cavity corresponding to the first dielectric sheet 1a is formed there between. Then, the dielectric material is cooled and solidified. Accordingly, the first dielectric sheet a is formed as shown in FIG. 2A (first forming process). Then, an upper die 10c having a shape such that a cavity corresponding to the second dielectric sheet 1b is formed between the upper die 10c and the first dielectric sheet 1a is place over the first dielectric sheet 1a. Then, the dielectric material in a molten state is injected into the cavity formed by the upper die 10c and the first dielectric sheet 1a, and is cooled and solidified. Accordingly, the second dielectric sheet 1b is formed on the first dielectric sheet 1a in such a manner that they are bonded together as shown in FIG. 2B (second forming process). In this process, the bonding surface of the first dielectric sheet 1a re-melts and the first and second dielectric sheets 1a and 1b are fusion-bonded to each other, so that the above-described melt-solidification layer a is formed.

Next, an upper die 10d having a shape such that a cavity corresponding to the third dielectric sheet 1c is formed is placed on the lower die 10b. Then, the dielectric material in a molten state is injected into the cavity formed between the upper die 10d and the first and second dielectric sheets 1a and 1b, and is cooled and solidified. Accordingly, the third dielectric sheet 1c is formed on the second dielectric sheet 1b in such a manner that they are bonded together as shown in FIG. 2C (third forming process). Lastly, an upper die 10e having a shape such that a cavity corresponding to the fourth dielectric sheet le is formed is placed on the lower die 10b. Then, the dielectric material in a molten state is injected into the cavity formed between the upper die 10e and the first, second, and third dielectric sheets 1a, 1b, and 1c, and is cooled and solidified. Accordingly, the fourth dielectric sheet 1d is formed on the third dielectric sheet 1c in such a manner that they are bonded together as shown in FIG. 2D (fourth forming process). Accordingly, the dielectric lens 1 having a hemispherical shape is manufactured.

As described above, in the dielectric lens 1 according to the present embodiment, the first dielectric sheet 1a is formed by injection molding, and the second dielectric sheet 1b is formed by directly injecting the dielectric material in a molten state on the upper surface of the first dielectric sheet 1a, so that the first dielectric sheet 1a and the second dielectric sheet 1b are bonded together. Similarly, the third dielectric sheet 1c is formed on the second dielectric sheet 1b by injection molding in such a manner that they are bonded together, and the fourth dielectric sheet 1d is formed on the third dielectric sheet 1c by injecting molding in such a manner that they are bonded together. Thus, processes of forming, laminating, and bonding the dielectric sheets, the processes being separately performed in the known art, can be performed by only the injection molding process. Accordingly, the manufacturing processes can be made simpler and productivity can be increased. In addition, costs can be reduced.

In addition, in the present embodiment, a fusion-bonding method is applied in which the first dielectric sheet 1a is formed by injection molding and the second dielectric sheet 1b is formed directing on the first dielectric sheet 1a by injection molding so that they are fusion-bonded to each other. Accordingly, compared with the known art in which an adhesive is used, bonding strength can be increased, so that separation of the dielectric sheets and generation of gaps can be prevented even under high temperature conditions. As a result, satisfactory antenna characteristics can be ensured for a long period of time.

TABLE 1

| | Testing Under High Temperature |
|---|---|
| | Condition (150° C.) |
| Lens of the Present Embodiment | No Problems have Occurred for 500 |
| Formed by Injection Molding | Hours |
| Lens Formed by Laminating | Separation Occurred in 100 Hours |
| Dielectric Sheets | |

Table 1 shows the time elapsed before the bonded surfaces were separated when the dielectric lens 1 was continuously heated to 150° C. As is apparent from Table 1, in the lens of the known art formed by laminating the dielectric sheets, separation occurred in 100 hours. In contrast, in the lens of the present embodiment formed by injection molding, separation did not occur even when the lens were heated for 500 hours.

As described above, in the present embodiment, the melt-solidification layers are formed at the boundary surfaces a between the first to fourth dielectric sheets 1a to 1d by fusion-bonding the first to fourth dielectric sheets 1a to 1d to each other. Accordingly, the bonding strength of the first to fourth dielectric sheets 1a to 1d can be increased and problems such as separation of the dielectric sheets, etc., can be reliably prevented, so that the quality can be ensured.

In addition, since the dielectric sheets are directly fusion-bonded to each other, the antenna characteristics can be improved compared with the case in which the dielectric lens is formed by integral injection molding, and mechanical characteristics similar to those obtained by integral injection molding can be obtained. Although the antenna gain is 27 to 28 dBi when the dielectric lens is formed by integral injection molding, the antenna gain can be improved to 30 to 32 dBi by applying the present embodiment.

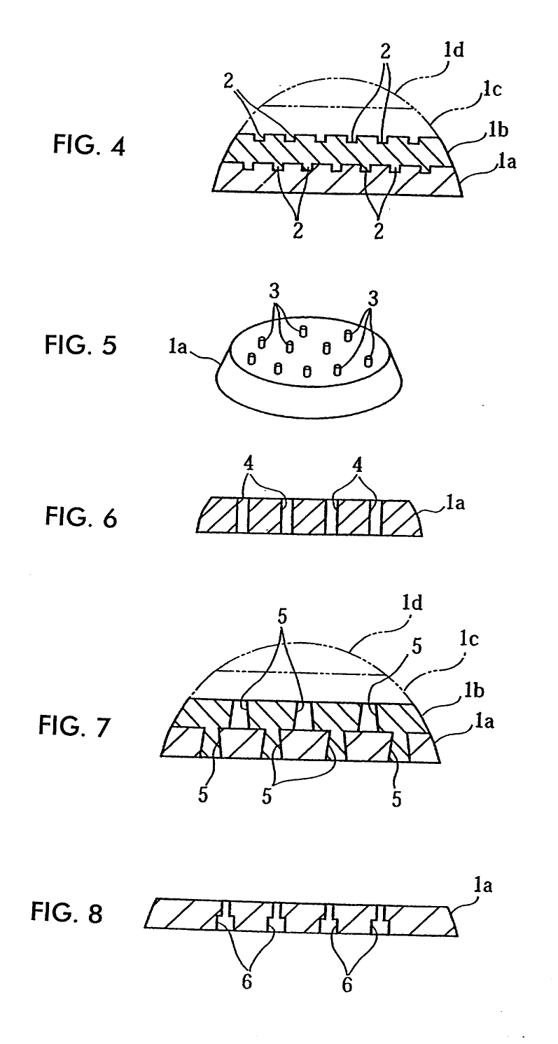

FIGS. 3 and 4 are diagrams for explaining a dielectric lens according to a second embodiment of the present invention.

In the present embodiment, a plurality of grooves 2 is formed in the bonding surfaces of the first to third dielectric sheets 1a to 1c, the grooves 2 extending in parallel to each other. When the dielectric material in a molten state is injected on the first dielectric sheet 1a, a part of the dielectric material for forming the second dielectric sheet 1b flows inside the grooves 2, so that line-shaped projections are formed. Thus, the bonding area between the first and second dielectric sheets 1a and 1b can be increased, so that the bonding strength can be further increased. Accordingly, problems such as separation of the dielectric sheets, etc., can be more reliably prevented.

FIGS. 5 and 6 show modifications of the above-described second embodiment.

FIG. 5 shows an example in which the bonding area between the first and second dielectric sheets 1a and 1b is increased by forming a plurality of projections 3 on the bonding surface of the first dielectric sheet 1a. In addition, FIG. 6 shows an example in which the bonding area between the first and second dielectric sheets 1a and 1b is increased by forming a plurality of through holes 4 in the first dielectric sheet 1a. In either case, the bonding strength can be increased and the effects similar to those obtained in the second embodiment can be obtained.

FIG. 7 is a diagram showing a dielectric lens according to a third embodiment of the present invention.

In the present embodiment, a plurality of holes 5 is formed in the first to third dielectric sheets 1a to 1c, the holes 5 having a shape such that the diameter thereof increases toward the lower side. When the dielectric material in a molten state is injected on the first dielectric sheet 1a, a part of the dielectric material for forming the second dielectric sheet 1b flows inside the holes 5, so that interlocking portions are formed. Accordingly, mechanical bonding strength between the first and second dielectric sheets 1a and 1b is increased. In addition, since a constricting strength is applied between the first and second dielectric sheets 1a and 1b due to the contraction of the second dielectric sheet 1b in the cooling process, the bonding strength can further be increased. Similarly, when the dielectric material for forming the third and fourth dielectric sheets is in a molten state, part of the dielectric material flows into the respective holes 5 of the second dielectric sheet 1a and the third dielectric sheet to form interlocking portions between the second and third dielectric sheets 1b and 1c and between the third and fourth dielectric sheets 1c and 1d, thereby further increasing bonding strength.

FIG. 8 shows a modification of the above-described third embodiment. In this case, a plurality of fitting holes 6 having a shape including a step is formed in the first dielectric sheet 1a. Also in this case, the bonding strength can be increased and the effects similar to those obtained in the third embodiment can be obtained.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A dielectric lens comprising at least a first dielectric sheet and a second dielectric sheet which are laminated along a focal axis, the first dielectric sheet being formed by injecting a dielectric material in a molten state into a die at a predetermined pressure and cooling and solidifying the dielectric material, and the second dielectric sheet being formed by injecting the dielectric material in a molten state into a die in which the first dielectric sheet is disposed and cooling and solidifying the dielectric material.

2. A dielectric lens according to claim 1, wherein concave and convex portions for increasing a bonding area are formed at the boundary between the first dielectric sheet and the second dielectric sheet.

3. A dielectric lens according to claim 2, wherein the concave portions includes a plurality of grooves formed on a top surface of the first dielectric sheet.

4. A dielectric lens according to claim 2, wherein the concave portions comprise a plurality of through holes formed in the first dielectric sheet.

5. A dielectric lens according to claim 2, wherein the convex portions comprise a plurality of projections formed on a top surface of the first dielectric sheet.

6. A dielectric lens according to claim 1, wherein interlocking portions for increasing a mechanical bonding strength are formed at the boundary between the first dielectric sheet and the second dielectric sheet.

7. A dielectric lens according to claim 6, wherein the interlocking portions include holes formed in the first dielectric sheet, the holes having a first diameter in a portion adjacent to the top surface of the first dielectric sheet and having a second, larger diameter in a portion disposed towards a lower surface of the first dielectric sheet.

8. A dielectric lens comprising a plurality of dielectric sheets formed along a focal axis of the lens, a first dielectric sheet being formed by injecting a dielectric material in a molten state at a predetermined pressure and cooling and solidifying of the dielectric material and each successive dielectric sheet being formed by injecting the dielectric material in a molten state on a preceding dielectric sheet and cooling and solidifying the dielectric material so that each successive dielectric sheet and each immediately preceding dielectric sheet are fusion-bonded to each other.

9. A dielectric lens according to claim 8, wherein there are four dielectric sheets, each having a thickness equal to one quarter the wavelength of the frequency of the electric wave with which the lens is to be used.

10. A dielectric lens according to claim 9, wherein successive dielectric sheets have progressively smaller diameters than the first dielectric sheet such that the plurality of sheets define a dielectric lens having a hemispherical shape.

11. A dielectric lens comprising a plurality of dielectric sheets disposed along a focal axis of the lens, successive dielectric sheets having progressively smaller diameters than a first one of the dielectric sheets such that the plurality of sheets define a dielectric lens having a hemispherical shape, each of the dielectric sheets being fusion-bonded to an adjacent dielectric sheet.

12. A dielectric lens according to claim 11, wherein there are four dielectric sheets, each having a thickness equal to one quarter the wavelength of the frequency of the electric wave with which the lens is to be used.

13. A manufacturing method for a dielectric lens which is formed by laminating at least a first dielectric sheet and a second dielectric sheet along a focal axis of the lens, the manufacturing method comprising:
a first forming step in which the first dielectric sheet is formed by injecting a dielectric material in a molten state into a die at a predetermined pressure, the die having a shape corresponding to the first dielectric sheet, and cooling and solidifying the dielectric material; and
a second forming step in which the second dielectric sheet is formed by injecting the dielectric material in a molten state into a die in which the first dielectric sheet is disposed at a predetermined pressure, the die having a shape such that a cavity corresponding to the second dielectric sheet is formed between the die and the first dielectric sheet, and cooling and solidifying the dielectric material, so that the first dielectric sheet and the second dielectric sheet are fusion-bonded to each other.

14. A manufacturing method for a dielectric lens which is formed by a plurality of dielectric sheets disposed along a focal axis of the lens, the manufacturing method comprising:
forming a first dielectric sheet by injecting a dielectric material in a molten state at a predetermined pressure and cooling and solidifying of the dielectric material; and
forming successive dielectric sheets by injecting the dielectric material in a molten state on a preceding dielectric sheet and cooling and solidifying the dielectric material so that each successive dielectric sheet and each immediately preceding dielectric sheet are fusion-bonded to each other.
